(19) United States
(12) Patent Application Publication
(10) Pub. No.: US 2008/0134456 A1
(43) Pub. Date: Jun. 12, 2008

(54) WIPER BLADE

(76) Inventor: YANG-GYU CHOI, Incheon City (KR)

Correspondence Address: NOTARO AND MICHALOS, 100 DUTCH HILL ROAD, SUITE 110, ORANGEBURG, NY, 10962-2100, US

(21) Appl. No.: 11/950,484

(22) Filed: Dec. 5, 2007

(30) Foreign Application Priority Data
Dec. 7, 2006 (KR) 10-2006-0125486

(51) Int. Cl. B60S 1/04

(52) U.S. Cl. 15/250.361

(57) ABSTRACT

A wiper blade is provided which more evenly distributes contact pressures on a windshield glass in a central portion and opposite end portions of the rubber element, prevents flotation of the opposite end portions and ensures the cleaning quality. The wiper blade comprises a primary lever on which a clip is rotatably mounted and which has a predetermined length, the clip being fastened to a connector of a wiper arm in a motor vehicle; a first and second fastening means mounted to opposite ends of the primary lever, respectively; a butterfly spring which is mounted on the first fastening means at one side of a center of the butterfly spring and which is mounted on the second fastening means at other side of the center of the butterfly spring, said butterfly spring having a predetermined length to provide elasticity; and, a rubber element which is fastened to the butterfly spring and contacts at the lower end portion with a windshield glass in the motor vehicle.

### BACKGROUND OF THE INVENTION

(1) Field of the Invention

The present invention relates in general to a wiper blade which is mounted on a wiper arm of a motor vehicle and which can clean a windshield glass surface more evenly regardless of changes in curvature and inclination of a windshield glass surface.

(2) Description of Related Art

Generally, a wiper blade is mounted on a front windshield glass of a motor vehicle, etc., to perform a function to clean the windshield glass in the motor vehicle.

Generally, a wiper blade is mounted on a front windshield glass of a motor vehicle, etc., to perform a function to clean the windshield glass in the motor vehicle.

As illustrated in FIGS. 1 to 3, such a conventional wiper blade generally comprises a rubber element 2 which ordinarily performs a function to directly clean rainwater or foreign substance from a windshield glass 1 in the motor vehicle, a butterfly spring 4 which functions to distribute a force applied by a wiper arm 3 so that the rubber element 2 can effectively contact the windshield glass 1, a spoiler 5 which functions to compensate for flotation of the wiper blade by a wind while the motor vehicle runs, an end cap 6 for fixing the butterfly spring 4 and the rubber element 2 to each other, a connector holder 7 which is fixed to the butterfly spring 4 and also fastened to a connector 3a of the wiper arm 3.

In such a conventional wiper blade as illustrated in FIG. 3, an application force of the wiper arm 3 is concentrated on a central portion under the connector holder 7 and weakens in opposite end portions, thereby causing differences in contact pressures between the central portion and the opposite end portions. In FIG. 3, “p” represents contact pressures.

Thus, a flotation phenomenon occurs in the opposite end portions of the wiper blade on end portion of which wipes the peripheral zone of the windshield glass 1 due to such differences in the contact pressures, and therefore a problem exists in that the windshield glass 1 is not cleaned properly as a whole.

Furthermore, in the conventional wiper blade, elasticity or curvature of the butterfly spring 4 varies so as to effectively contact the rubber element 2 with the windshield glass 1 according to the shape of the windshield glass 1, thereby limiting conditions to be commonly used according to kinds of the motor vehicles, and therefore another problem still exists in that the wiper blade should be inconveniently selected according to the motor vehicle.

Meanwhile, the spoiler 5 of the conventional wiper blade is formed of a streamline shape in order to prevent the flotation of the wiper blade while the motor vehicle runs. But, when the motor vehicle runs at high speed, a water-drawn phenomenon severely occurs that, as illustrated in FIG. 4, water is not blocked, but continuously flows following the returning wiper blade due to air eddies 100 toward a rear side of the wiper blade while the wiper blade is operated toward the lower end after the wiper blade wipes water upwardly and turns in the reverse. Thus, the windshield glass 1 is not cleaned properly and the conventional wiper blade has a disadvantage that it occurs an impediment in a visual range of a driver.

Another prior art supporting element for a wiper blade belonging to a windshield glass wiper in a motor vehicle is disclosed in Korean Patent Laid-open Publication No. KR 10-2001-20400A, which is made of a flexible material. The blade is fixed parallel to the longitudinal axis, facing a windshield glass on a lower surface of an oblong elastic supporting element which is produced using an interlaced fiber material impregnated with a reaction mixture. The supporting element is particularly easy and inexpensive to produce if it is made entirely of fiber material impregnated with a reaction mixture.

Further another prior art wiping device for glass surfaces of motor vehicles is disclosed in Korean Patent Laid-open Publication No. KR 10-2001-99978A, which comprises a connection device that has a hinge pin having an axis that extends essentially crosswise in relation to the longitudinal direction of the wiper blade and in the working direction of the wiping device, and a coupling component with a bearing recess for the hinge pin which can be introduced into the bearing recess by means of an assembly channel. An introduction opening of the assembly channel is arranged on the side of the coupling component, said side facing away from the glass surface. A robust securing device is obtained by providing the assembly channel with two partial channels. Said partial channels form an angle of less than 180 degree. One partial channel is provided with the introduction opening for the hinge pin. The other partial channel leads into the bearing recess.

However, such prior art wiper blades also have the similar problems mentioned above relating to the conventional wiper blade.

### BRIEF SUMMARY OF THE INVENTION

Accordingly, the present invention is made in order to solve the above problems, and one object of the present invention is to provide a wiper blade which more evenly distributes contact pressures on a wind shield glass by directly transmitting an application force of a wiper arm even on opposite end portions of the wiper blade, and at the same time is designed to prevent flotation of the opposite end portions of the wiper blade.

Further, it is another object of the present invention to provide a wiper blade which can be used in common for various kinds of motor vehicles, ensures cleaning quality, and at the same time, minimizes air eddies occurring in a rear side of the wiper blade while the motor vehicle runs at high speed.

To accomplish the objects of this invention, a wiper blade is provided in accordance with one embodiment of the invention, which comprises a primary lever on which a clip is rotatably mounted and which has a predetermined length, the clip being fastened to a connector of a wiper arm in a motor vehicle; a first and second fastening means mounted to opposite ends of the primary lever, respectively; a butterfly spring which is mounted on the first fastening means at one side of a center of the butterfly spring and which is mounted on the second fastening means at other side of the center of the butterfly spring, said butterfly spring having a predetermined length to provide elasticity; and, a rubber element which is fastened to the butterfly spring and contacts at the lower end portion with a windshield glass in the motor vehicle.

### BRIEF DESCRIPTION OF THE SEVERAL VIEWS OF THE DRAWINGS

The invention will now be described by way of non-limitative example with reference to the following drawings.

FIG. 1 illustrates a front view of a conventional wiper blade.

FIG. 2 illustrates a schematically cross-sectional view along section line A-A shown in FIG. 1.

FIG. 3 illustrates a contact pressure distribution diagram in the wiper blade of FIG. 1.

FIG. 4 illustrates a schematically cross-sectional view along section line A-A of FIG. 1 for further showing air flow surrounding the wiper blade while a motor vehicle runs at high speed.

FIG. 5 shows a perspective view of a wiper blade according to one embodiment of the present invention.

FIG. 6 illustrates a front view of the wiper blade according to one embodiment of the present invention.

FIG. 7 illustrates a schematically cross-sectional view along section line B-B shown in FIG. 6.

FIG. 8 illustrates a plan view of a butterfly spring according to one embodiment of the present invention.

FIG. 9 illustrates a contact pressure distribution diagram on the windshield glass along the wiper blade according to one embodiment of the present invention.

FIG. 10 illustrates a plan view of a butterfly spring according to another embodiment of the present invention.

FIG. 11 illustrates a plan view of a butterfly spring according to further another embodiment of the present invention.

FIG. 12 is a schematically cross-sectional view along section line C-C of FIG. 11.

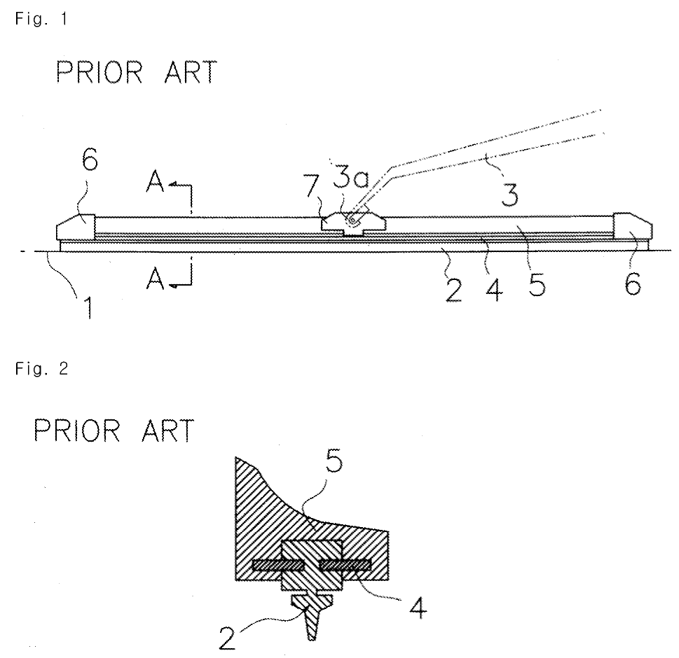

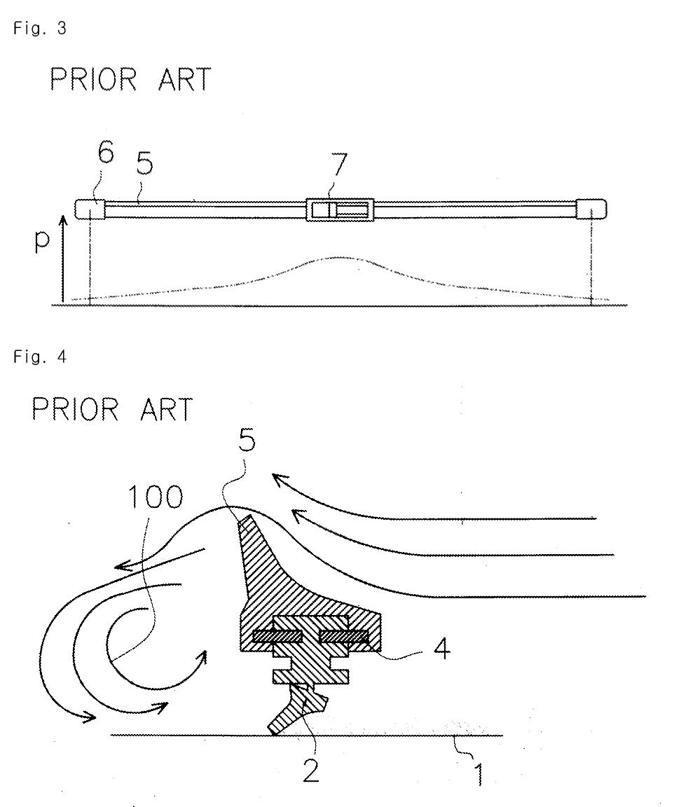

### DETAILED DESCRIPTION OF THE INVENTION

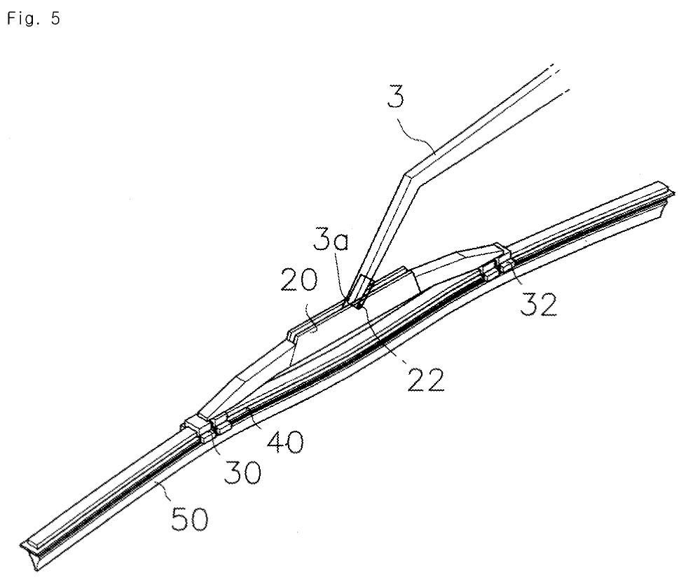

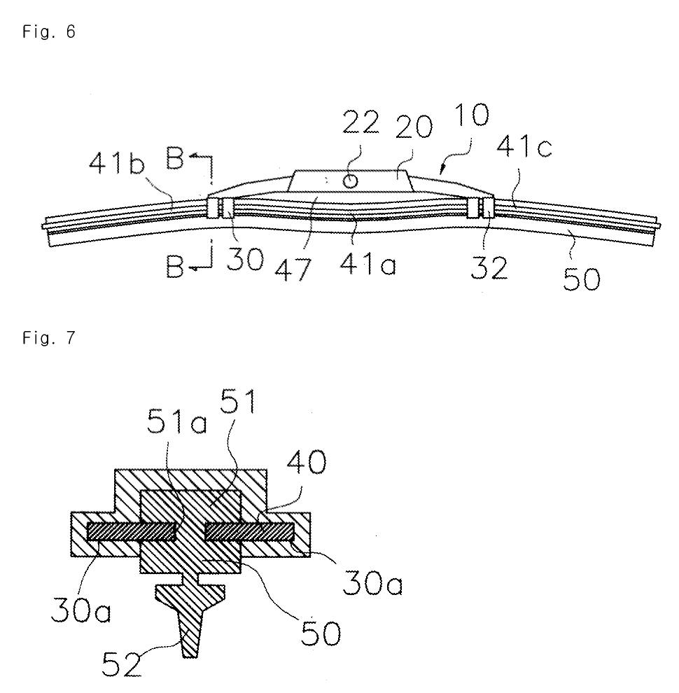

Preferred embodiments of the present invention will be described in detail with reference to FIGS. 5-12.

In FIGS. 5 to 9, a wiper blade 10 according to one embodiment of the present invention comprises a primary lever 20 on which a clip 22 is rotatably mounted and which has a predetermined length, the clip 22 being fastened to an U-shaped connector 3a of a wiper arm 3 in a motor vehicle; a first and second fastening means 30 and 32 mounted to opposite ends of the primary lever 20, respectively; a butterfly spring 40 which is mounted on the first fastening means 30 at one side of a center of the butterfly spring 40 and which is mounted on the second fastening means 32 at other side of the center of the butterfly spring 40, said butterfly spring 40 having a predetermined length to provide elasticity; and, a rubber element 50 which is fastened to the butterfly spring 40 and contacts at the lower end portion with a windshield glass 1 in the motor vehicle.

Here, the butterfly spring 40 is formed of an elastic material and has a curvature and a length for cleaning a desirable zone of the windshield glass 1. The butterfly spring 40 has a body 41, which comprises a downwardly sagging portion 41a formed at a center portion of the body 41, and a first and second upwardly protruding portions 41b and 41c formed at opposite sides of the center of the butterfly spring 40 so as to form a seagull shape as a whole. And, the butterfly spring 40 has a prescribed width and a slot 42 for fastening the rubber element 50 along the longitudinal direction of the body 41.

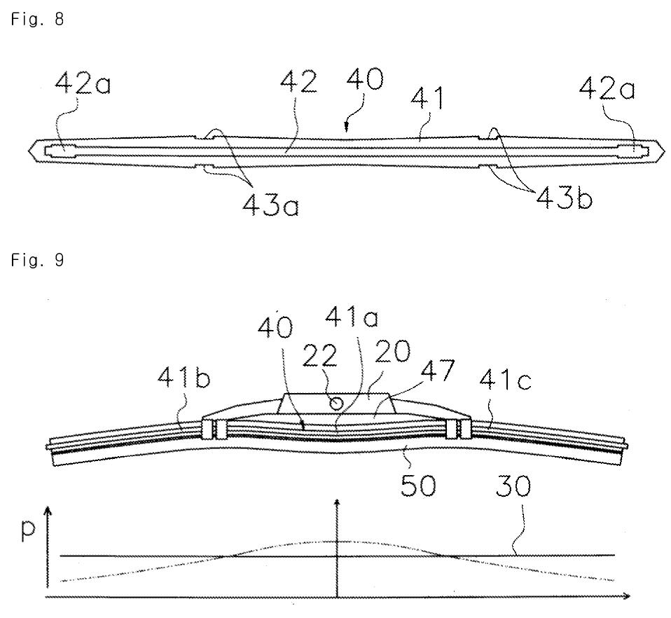

Furthermore, as shown in FIG. 8, the butterfly spring 40 has a narrow shape formed at each of a central portion and opposite end portions thereof, and a pair of first and second fastening grooves 43a and 43b at traversely opposite sides of the first and second protruding portions 41b and 41c. Said first and second fastening means 30 and 32 fasten the butterfly spring 40 at said first and second fastening grooves 43a and 43b. And, the first and second fastening means 30 and 32 can be formed integrally with the primary lever 20 at opposite end lower portions of the primary lever 20, and has a pair of first catching recesses 30a and a pair of second catching recesses not shown formed at each of their lower portions as shown in FIG. 7. Although the second catching recesses are not shown, it can be understood that the second catching recesses are identical with the first catching recesses 30a since the first and second fastening means 30 and 32 are identical with each other in shape.

The first catching recesses 30a of the first fastening means 30 and the first fastening grooves 43a of the first protruding portions 41b of the butterfly spring 40 are engaged with each other, and similarly the second catching recesses not shown of the second fastening means 32 and the second fastening grooves 43b of the second protruding portions 41c of the butterfly spring 40 are engaged with each other. Thus, the butterfly spring 40 can be mounted on the first fastening means 30.

Meanwhile, the butterfly spring 40 is formed of a seagull shape and provided with a space 47 between the sagging portion 41a and the primary lever 20. Such a space 47 allows air to flow passing through the wiper blade, and therefore, removes some of air eddies occurring in the rear side of the wiper blade while the motor vehicle runs at high speed.

The rubber element 50 is fastened to the slot 42 formed on the butterfly spring 40 for wiping rainwater or foreign substance from a windshield glass 1. The rubber element 50 has inserting grooves 51a formed along opposite sidewalls of a body 51 of the rubber element 40 in the longitudinal direction so as to be inserted into the slot 42 of the butterfly spring 40. The inside edges of the slot 41 are engaged into the inserting grooves 51a, thereby preventing the rubber element 50 from being separated. Also, the rubber element 50 has a sharp contact portion 52 protruded at a lower end of the body 51 of the rubber element 50 along the longitudinal direction, which contacts the surface of the windshield glass 1.

Meanwhile, an enlarged inserting hole 42a is further provided at each opposite end of the slot 42 of the butterfly spring 40, thereby facilitating replacement of the rubber element 50.

Now, distribution of contact pressures p on the windshield glass 1 along the wiper blade according to the present invention will be described in detail with reference to FIG. 9. In FIG. 9, “p” represents pressure.

The force transmitted by the wiper arm 3 is transmitted to the primary lever 20 through the clip 22. The transmitted force is distributed according to the elasticity characteristics of the butterfly spring 40 arranged on the basis of the surface of the windshield glass 1.

That is, the force applied by the wiper arm 3 is divided into the first and second fastening means 30 and 32 provided at the opposite end lower portions of the primary lever 20 and then transmitted to the butterfly spring 40.

At this moment, each force applied to the first and second fastening means 30 and 32 is transmitted to, and presses, the first and second protruding portions 41b and 41c formed at the opposite sides of the center of the butterfly spring 40. Thus, the sagging portion 41a and the opposite ends of the butterfly spring 40 come into first contact with the windshield glass 1, and are pressed in the rubber element 50. Then, the first and second protruding portions 41b and 41c become contacted with the windshield glass 1 and pressed, and therefore the divided forces are evenly distributed as contact pressures along the surface curvature of the windshield glass 1. Thus, close contact between the sharp contact portion 52 of the rubber element 50 and the surface of the windshield glass 1 is obtained over all the surface of the windshield glass 1, and moreover, flotation of the opposite end portions of the wiper blade is prevented.

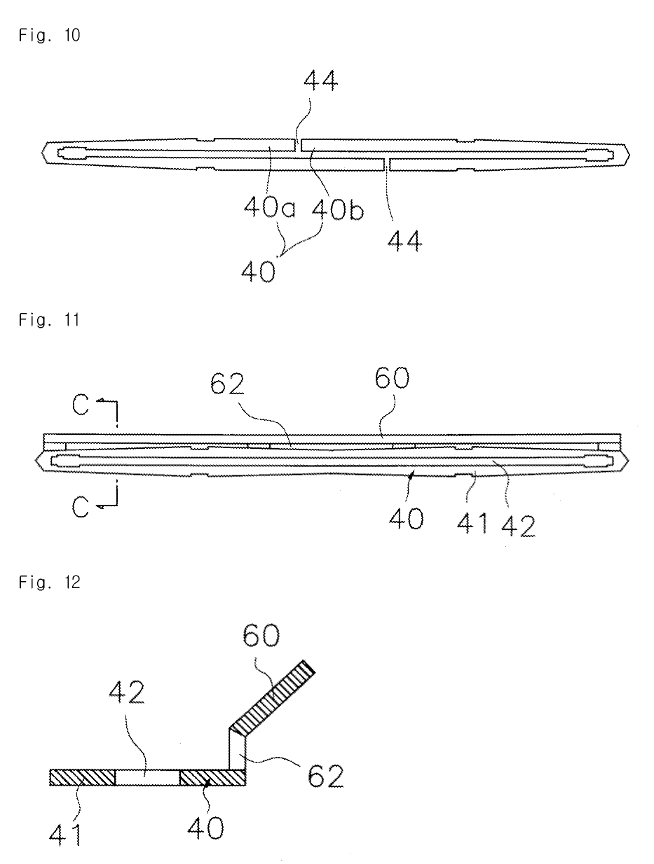

In the meantime, a butterfly spring according to another embodiment of the present invention is shown in FIG. 10, as a plan view. In FIG. 10, a pair of opening portions 44 are traversely formed at the central portion of the body 41, which divides the butterfly spring 40 into a first and second butterfly spring portions 40a and 40b. By such a structure, when the force by the wiper arm 3 is applied to the butterfly spring 40, the contact action between the sharp contact portion 52 of the rubber element 50 and the surface of the windshield glass 1 is performed smoothly with the width of the opening portions 44 decreased.

Furthermore, a butterfly spring according to still another embodiment of the present invention is shown in FIGS. 11 and 12, as a plan view. In FIGS. 11 and 12, a spoiler 60 is embodied integrally with the butterfly spring 40 at one side thereof in the traverse direction, which compensates for flotation of the wiper blade by a wind while the motor vehicle runs.

That is, the spoiler 60 comprises an inclined surface maintained at a certain angle in order to prevent flotation of the wiper blade by a wind while the motor vehicle runs. In such a case, when the motor vehicle runs at high speed, a sever water-drawn phenomenon can occur that water is not blocked, but continuously flows following the wiper blade due to air eddies toward the rear side of the wiper blade while the wiper blade is operated toward the lower end after the wiper blade wipes water upwardly and turns in the reverse. Therefore, as in FIG. 12, the spoiler 60 is preferably formed integrally with the butterfly spring 40, leaving a space portion 62 serving as an air-passage so that generation of air eddies at the rear side of the wiper blade can be minimized.

Conclusively, as described above, in the wiper blade according to the present invention, the force applied by the wiper arm 3 is directly divided into the opposite end lower portions of the primary lever 20 by the fastening means 30 and 32, and then distributed evenly to the central portion and the opposite end portions of the rubber element 50 by the seagull shape of the wiper blade. Thus, the present invention has an advantage that contact pressures on the windshield glass 1 are improved and flotation at the opposite end portions of the rubber element 50 is prevented, thereby improving cleaning characteristic of the windshield glass 1.

Furthermore, the present invention can satisfy various conditions in inclination or curvature of the windshield glasses of the motor vehicles and increase the contact pressures particularly in the opposite end portions of the wiper blade. Therefore, the present invention has another advantage that the wiper blade according to the present invention can be used commonly for the various curvatures in the windshield glasses of the motor vehicles with an improved inclination-trace characteristic and excellent cleaning quality.

Although the present invention has been explained by the embodiments shown in the drawings described above, the present invention is not limited to the embodiments, but rather that various changes or modifications thereof are possible without departing from the spirit of the present invention. Accordingly, the scope of the present invention shall be determined only by the appended claims and their equivalents.

1. A wiper blade comprising:
a primary lever (20) on which a clip (22) is rotatably mounted and which has a predetermined length, the clip (22) being fastened to a connector (3a) of a wiper arm (3) in a motor vehicle;
a first and second fastening means (30 and 32) mounted to opposite ends of the primary lever (20), respectively;
a butterfly spring (40) which is mounted on the first fastening means (30) at one side of a center of the butterfly spring (40) and which is mounted on the second fastening means (32) at other side of the center of the butterfly spring (40), said butterfly spring (40) having a predetermined length to provide elasticity; and,
a rubber element (50) which is fastened to the butterfly spring (40) and contacts at the lower end portion with a windshield glass (1) in the motor vehicle.

2. A wiper blade according to claim 1:
wherein the first and second fastening means (30 and 32) are formed integral with the primary lever (20) at opposite end lower portions of the primary lever (20) and has each pair of first and second catching recesses in the downward direction; and,
wherein the butterfly spring (40) has a body (41) which comprises a downwardly sagging portion formed at the center portion of the body (41) and a first and second upwardly protruding portions (41b and 41c) formed at opposite sides of the center of the butterfly spring (40) so as to form a seagull shape, the first and second upwardly protruding portions (41b and 41c) being supported by the first and second catching recesses of the first and second fastening means (30 and 32).

3. A wiper blade according to claim 1, wherein the butterfly spring (40) is formed of an elastic material with a prescribed width, and has a body (41) and a slot (42) for fastening the rubber element (50) along the longitudinal direction of the body (41), and an enlarged inserting hole (42a) is further provided at each opposite end of the slot (42) of the butterfly spring (40) to replace the rubber element (50) easily.

4. A wiper blade according to claim 1, wherein the butterfly spring (40) has a narrow shape at each of the central portion and the opposite end portions thereof.

5. A wiper blade according to claim 1, wherein the butterfly spring (40) is divided into a first and second butterfly spring portions (40a and 40b) by forming a pair of opening portions (44) at the central portion of the body (41).

6. A wiper blade according to claim 1, wherein the butterfly spring (40) has a spoiler (60) formed integrally at one side in the traverse direction in order to prevent flotation of the wiper blade by a wind while the motor vehicle runs.

7. A wiper blade according to claim 6, wherein the spoiler (60) is arranged apart from the butterfly spring (40) so as to form a gap (62) for air flowing therebetween.
